(19) United States
(12) Patent Application Publication
(10) Pub. No.: US 2011/0079759 A1
(43) Pub. Date: Apr. 7, 2011

(54) SUPPORT FOR PERFORMING MAINTENANCE ON A RIDING LAWN MOWER

(76) Inventor: DAVID OJEDA, East Haddam, CT (US)

(21) Appl. No.: 12/627,129

(22) Filed: Nov. 30, 2009

Related U.S. Application Data
(60) Provisional application No. 61/248,027, filed on Oct. 2, 2009.

(51) Int. Cl. B66F 5/00; B66F 3/00

(52) U.S. Cl. 254/3 R

(57) ABSTRACT

Apparatus for elevating and supporting an associated riding lawn mower which includes a hand truck assembly having a generally inverted U-shaped frame attached to an axle cooperating with first and second axially spaced wheels carried thereon and having a generally planar tongue for supporting an associated objects to be moved; and a carriage assembly dimensioned and configured for mounting on the hand truck assembly, the carriage assembly wheels have supports for engaging the respective first and second wheels of the associated riding lawn mower, the carriage assembly is supported on the hand truck assembly by means of an opening in the carriage assembly engaging the tongue of the hand truck assembly whereby placement of the associated lawnmower on the supports of the carriage assembly while engaged with the hand truck assembly followed by rotational movement of the frame of the hand truck assembly from a generally vertical position to a generally horizontal position results in the elevation of the associated lawn mower to enablement maintenance thereon.

### RELATED APPLICATIONS

This application is a continuation of provisional U.S. patent application 61/248,027, filed Oct. 2, 2009 by the present applicant. This application is incorporated by reference herein.

### FIELD OF THE INVENTION

The invention has particular application to methods and apparatus for performing maintenance on riding lawnmowers and the like.

### BACKGROUND OF THE INVENTION

Various apparatus has been provided to support riding lawn mowers to allow access to the structure of the mower that is only accessible from the bottom. It is necessary to access this structure, for example, on a rotary blade lawn mower, to change the blade, to sharpen the blade, or clean the area of the blade and remove grass that clings to the undercarriage in the process of normal lawn mowing.

While the present invention has particular application to rotary blade lawn mowing apparatus, those skilled in the art will recognize that the present invention also has application to other apparatus which is heavy and/or bulky and thus complicates performing maintenance on the apparatus.

The present invention utilizes a modified hand truck as a part of the apparatus for supporting a riding lawnmower or the like. A hand truck, also known as a dolly, two-wheel dolly, stack truck, trolley, sack truck or bag barrow, is an L-shaped box-moving handcart with handles at one end, wheels at the base, with a small ledge or tongue to set objects on, flat against the floor when the hand-truck is upright. The objects to be moved are tilted forward, the ledge or tongue is inserted underneath them, and the objects allowed to tilt back toward the handle while resting on the tongue. Then the truck and object are tilted further backward until the weight is balanced over the wheels, making otherwise bulky and heavy objects easier to move. The handle may be referred to herein as “handle bars” and it will be understood the handlebars commonly have an inverted U-shaped form. Thus, there are two elongated legs of the inverted U-shaped handle bars.

### SUMMARY OF THE INVENTION

It is an object the preservation to provide apparatus that will raise a lawn mower, especially a rotary riding lawn mower to an elevated position which facilitates the performance of maintenance as well as cleaning operations on the mower.

A further object of the present invention is to provide a structure that includes structure that can be used as a conventional hand truck as well as combined with other apparatus in accordance with the present invention to be used to support a lawn mower.

An additional object is to provide such apparatus in a manner that is safe and easy to use.

It has now been found that these and other objects of the invention may be achieved in apparatus for elevating and supporting an associated riding lawn mower which includes a hand truck assembly having a generally inverted U-shaped frame attached to an axle cooperating with first and second axially spaced wheels carried thereon and having a generally planar tongue for supporting an associated objects to be moved; and a carriage assembly dimensioned and configured for mounting on the hand truck assembly, the carriage assembly wheels having supports for engaging the respective first and second wheels of the associated riding lawn mower, the carriage assembly been supported on the hand truck assembly by means of an opening in the carriage assembly engaging the tongue of the hand truck assembly whereby placement of the associated lawnmower on the supports of the carriage assembly while engaged with the hand truck assembly followed by rotational movement of the frame of the hand truck assembly from a generally vertical position to a generally horizontal position results in the elevation of the associated lawn mower to enablement maintenance thereon. Some forms of the invention include a stop assembly having a foot that is manually movable between a retracted position and an extended position. The stop assembly in the extended a position preventing rotational movement of the hand truck assembly when supporting an associated lawnmower.

The apparatus may further include first and second spaced arms pivotally carried on the carriage assembly and have free ends provided with respective clamps for engaging the frame of the hand truck assembly.

The apparatus may further include a rest attached to the carriage assembly dimensioned and configured for seating on the floor or other support surface under the carriage assembly when the frame of the hand truck is generally horizontal.

Some forms of the apparatus may include a stop assembly having a foot that is manually movable between a retracted position and an extended position, the stop assembly in the extended a position preventing rotational movement of the hand truck assembly winds supporting an associated lawnmower; first and second spaced arms pivotally carried on the carriage assembly and having free ends provided with respective clamps for engaging the frame of the hand truck assembly and a rest attached to the carriage assembly dimensioned and configured for seating on the floor or other support surface under the carriage assembly when the frame of the carriage is generally horizontal.

Other forms of the apparatus for elevating and supporting an associated riding lawn mower utilizing an associated hand truck having a generally inverted U-shaped frame attached to an axle cooperating with first and second axially spaced wheels carried thereon and having a generally planar tongue for supporting an associated objects to be moved which include a carriage assembly dimensioned and configured for mounting on the associated hand truck assembly. The carriage assembly wheels has supports for engaging the respective first and second wheels of the associated riding lawn mower, the carriage assembly is on the hand truck assembly by means of an opening in the carriage assembly engaging the tongue of the hand truck assembly whereby placement of the associated lawnmower on the supports of the carriage assembly while engaged with the hand truck assembly followed by rotational movement of the frame of the hand truck assembly from a generally vertical position to a generally horizontal position results in the elevation of the associated lawn mower to enablement maintenance thereon.

This embodiment may further including first and second spaced arms pivotally carried on the carriage assembly and having free ends provided with respective clamps for engaging the frame of the hand truck assembly.

### BRIEF DESCRIPTION OF THE DRAWING

The invention will be better understood by reference to the accompanying drawing in which:

FIG. 1 is a side elevation view of a preferred embodiment of the hand truck and carriage assembly in accordance one form of the present invention illustrating the carriage portion partially folded.

FIG. 2 is a perspective view of the carriage before installation on the hand truck.

FIG. 3 is a schematic side elevation view of a portion of the carriage illustrating alternative placement of pockets for receiving the tongue of the hand truck by which the carriage is secured, in part, to the hand truck.

FIG. 4 is an isometric view illustrating a stop that is provided to prevent inadvertent rotation of the hand truck in a manner that would lower the associated riding lawnmower resulting in possible injury to the user.

### DESCRIPTION OF THE PREFERRED EMBODIMENTS

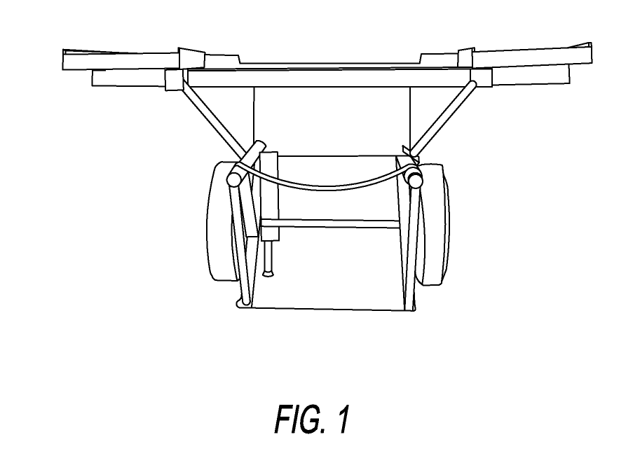

Referring now to FIGS. 1-5, the present invention utilizes a modified hand truck assembly 10 as a part of the apparatus for supporting a riding lawnmower or the like. The hand truck assembly 10 is an L-shaped handcart with respective legs 12 that telescopically engage handle bar 55 at one end of the hand truck, wheels 14 at the base, with a small ledge or tongue 16 (normally used to set objects on) used to engage a carriage assembly 20. It will be understood that a conventional hand truck tongue is disposed flat against the floor when the hand-truck is upright.

In a conventional hand truck objects to be moved are tilted forward, the ledge or tongue of the hand truck is inserted underneath them, and the objects allowed to tilt back and rest on the tongue. Then the truck and object are tilted backward until the weight is balanced over the large wheels, making otherwise bulky and heavy objects easier to move. The handle may be referred to herein as “handle bars” and it will be understood the handlebars commonly have an inverted U-shaped form. Thus, there are two elongated legs 12 of the inverted U-shaped handle bars are identified in FIG. 1.

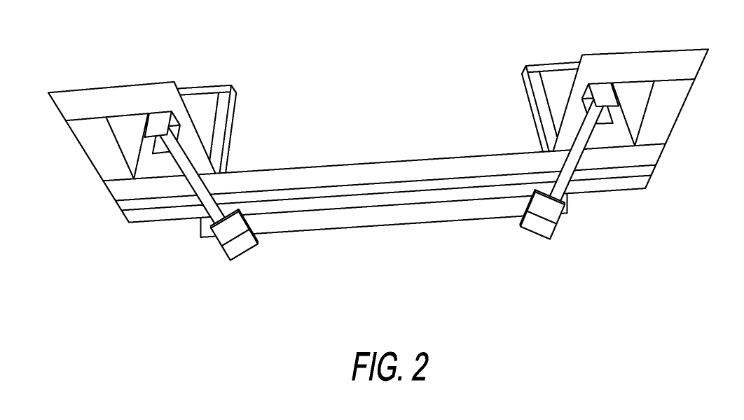

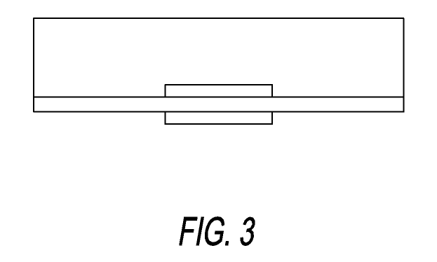

In the present apparatus and the tongue 16 engages the carriage assembly 20. In addition two arms 22 are pivotally connected to the carriage assembly 20 by respective brackets 24 The opposite ends of the arms 22 are connected by clamps 26 to respective legs 12. The carriage assembly 20 and includes respective supports 28 guy mentioned and configured for receiving the wheels of associated lawnmower 50 as best seen in FIG. 5. Wheel stops 30 adjacent to the respective supports 28 may fold as shown in FIG. 1 or unfold as shown in FIG. 2. In the unfolded mode the stops 30 prevent rearward motion of the associated lawnmower 50. It will be understood that typically the apparatus is used to engage the two front wheels of a lawnmower 50 having four wheels. As shown schematically in FIG. 3 the carriage assembly 20 may include an angle iron member extending the width of the carriage assembly 20 and proximate to the juncture of the supports 28 and the stops 30. In some embodiments of the present invention the tongue 16 of the hand truck assembly 10 may engage a slot 44 formed below the angle iron 42. In other embodiments a slot 46 may be cut into the wall of the angle iron 42 for receiving the tongue 10. Normally, the entrance to either the slot 46 or the pocket 44 will be provided with tapered guides to direct the tongue 16 into engagement. Preferences between these embodiments are dependent upon the ease of establishing a firm interface between the carriage assembly 20 and the hand truck assembly 10. Ordinarily, embodiments using either the slot 46 or the pocket 44 will be provided with tapered guide members 45 on opposed sides thereof to guide the tongue 10 into engagement with the angle iron 42 portion of the carriage 20.

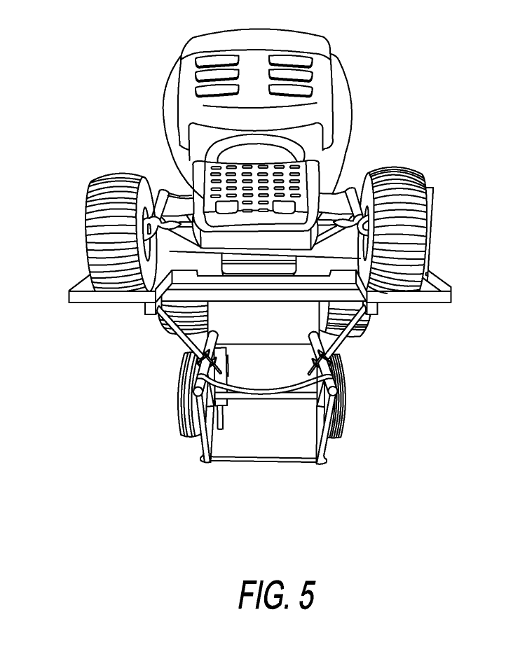

Referring now to FIG. 4 there is shown in greater detail a stop 52 that includes an L-shaped member 54. As shown in FIG. 4 the position of the L-shaped member prevents rotation of the hand truck assembly 10, carriage assembly 20 and lawnmower 50 after the combination has been elevated to the position shown in FIG. 5. The L-shaped member is in a preferred embodiment constrained by a key (not shown) on the side of a circular shaft which engages respective elongated slots (not shown) to lock the L-shaped member in either the down and locked position or up and retracted position as manually selected by the operator of the apparatus.

It will thus be seen that the user of the apparatus of the present invention may mount the carriage assembly 20 on the hand truck assembly 10, position the front wheels of associated lawnmower 50 on the supports 28, rotate the handlebar 55 and legs 12 from a substantially vertical position to a substantially horizontal position as shown in FIGS. 1 and 5, and extend the L-shaped member 54 as shown in FIG. 4 to prevent rotation of the hand truck assembly 10 to achieve safe and secure elevation of the lawnmower 50 and thereby allow easy maintenance thereon. It will be seen that the apparatus is supported on L-shaped member 54 as well as the framework 57 (fixed to the legs 12) when the lawn mower 50 is supported.

Other embodiments of the present may utilize a carriage assembly that is adapted with a variety of off the shelf hand trucks. Such embodiments will engage the tongue of the hand truck.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. Apparatus for elevating and supporting an associated riding lawn mower which comprises:
a hand truck assembly having a generally inverted U-shaped frame attached to an axle cooperating with first and second axially spaced wheels carried thereon and having a generally planar tongue for supporting an associated objects to be moved; and
a carriage assembly dimensioned and configured for mounting on said hand truck assembly, said carriage assembly wheels having supports for engaging the respective first and second wheels of the associated riding lawn mower, said carriage assembly been supported on said hand truck assembly by means of an opening in said carriage assembly engaging said tongue of said hand truck assembly whereby placement of the associated lawnmower on the supports of said carriage assembly while engaged with the hand truck assembly followed by rotational movement of the frame of the hand truck assembly from a generally vertical position to a generally horizontal position results in the elevation of the associated lawn mower to enablement maintenance thereon.

2. The apparatus as described in claim 1 further including a stop assembly having a foot that is manually movable between a retracted position and an extended position, said stop assembly in said extended a position preventing rotational movement of said hand truck assembly when supporting an associated lawnmower.

3. The apparatus as described in claim 1 further including first and second spaced arms pivotally carried on said carriage assembly and having free ends provided with respective clamps for engaging the frame of the hand truck assembly.

4. The apparatus as described in claim 1 further including a rest attached to said carriage assembly dimensioned and configured for seating on the floor or other support surface under the carriage assembly when the frame of the hand truck is generally horizontal.

5. The apparatus as described in claim 1 further including a stop assembly having a foot that is manually movable between a retracted position and an extended position, said stop assembly in said extended a position preventing rotational movement of said hand truck assembly winds supporting an associated lawnmower; first and second spaced arms pivotally carried on said carriage assembly and having free ends provided with respective clamps for engaging the frame of the hand truck assembly and a rest attached to said carriage assembly dimensioned and configured for seating on the floor or other support surface under the carriage assembly when the frame of the carriage is generally horizontal.

6. Apparatus for elevating and supporting an associated riding lawn mower utilizing an associated hand truck having a generally inverted U-shaped frame attached to an axle cooperating with first and second axially spaced wheels carried thereon and having a generally planar tongue for supporting an associated objects to be moved which comprises:
a carriage assembly dimensioned and configured for mounting on said hand truck assembly, said carriage assembly wheels having supports for engaging the respective first and second wheels of the associated riding lawn mower, said carriage assembly been supported on said hand truck assembly by means of an opening in said carriage assembly engaging said tongue of said hand truck assembly whereby placement of the associated lawnmower on the supports of said carriage assembly while engaged with the hand truck assembly followed by rotational movement of the frame of the hand truck assembly from a generally vertical position to a generally horizontal position results in the elevation of the associated lawn mower to enablement maintenance thereon.

7. The apparatus as described in claim 6 further including first and second spaced arms pivotally carried on said carriage assembly and having free ends provided with respective clamps for engaging the frame of the hand truck assembly.
